(19) United States
(12) Patent Application Publication
(10) Pub. No.: US 2020/0182769 A1
(43) Pub. Date: Jun. 11, 2020

(54) PARTICLE COUNTER

(71) Applicant: NGK INSULATORS, LTD., Nagoya-City (JP)

(72) Inventors: Hidemasa OKUMURA, Nagoya-City (JP); Kazuyuki MIZUNO, Nagoya-City (JP); Keiichi KANNO, Nagoya-City (JP)

(73) Assignee: NGK INSULATORS, LTD., Nagoya-City (JP)

(21) Appl. No.: 16/789,996

(22) Filed: Feb. 13, 2020

Related U.S. Application Data
(63) Continuation of application No. PCT/JP2018/024167, filed on Jun. 26, 2018.

(30) Foreign Application Priority Data
Aug. 22, 2017 (JP) 2017-159492

(51) Int. Cl. G01N 15/06; B03C 3/41; B03C 3/45

(52) U.S. Cl. CPC G01N 15/0656; B03C 3/455; B03C 3/41

(57) ABSTRACT

A particle counter includes a ventilation path, an electric-charge generator that applies the electric charge to a particle in the gas that passes through the ventilation path to obtain a charged particle, a charged-particle-collecting electrode, a heater that is capable of heating the ventilation path, and a controller for performing a particle count detection process, wherein, when the process is performed, the controller obtains a flow rate of the gas on the basis of a calorific value that is supplied to the heater and a difference between the temperature of the gas and the temperature of the surface of the heater, with the heater heating the ventilation path, and obtains the count of the particle per unit volume in the gas on the basis of the flow rate of the gas and a physical quantity that varies depending on an electric charge amount of the charged particle.

### BACKGROUND OF THE INVENTION

### 1. Field of the Invention

The present invention relates to a particle counter.

### 2. Description of the Related Art

A known particle counter generates ions by corona discharge of an electric-charge-generating element, charges particles in a measurement-object gas by using the ions, collects charged particles, and measures a particle count on the basis of the electric charge amount of the collected particles. For such a particle counter, there is a proposition that the collected particles are heated and incinerated by a heater, or particles that are accumulated in a gas inlet or a gas outlet are heated and incinerated by a heater (see, for example, PTL 1).

### CITATION LIST

### Patent Literature

PTL 1: WO 2015/146456 A1

### SUMMARY OF THE INVENTION

To obtain the particle count per unit volume in the measurement-object gas, it is necessary to use the flow rate of the measurement-object gas. However, the particle counter in PTL 1 does not have a function of measuring the flow rate of the measurement-object gas, and the particle count per unit volume in the measurement-object gas cannot be obtained.

The present invention has been accomplished to solve the problem, and it is a primary object of the present invention to obtain the particle count per unit volume in gas.

A particle counter according to a first aspect of the present invention includes a housing that has a ventilation path, a gas-temperature gauge that measures a temperature of gas that passes through the ventilation path, an electric-charge generator that generates an electric charge by air discharge in the ventilation path and applies the electric charge to a particle in the gas that passes through the ventilation path to obtain a charged particle, a charged-particle-collecting electrode that collects the charged particle, a heater that is capable of heating the ventilation path, a heater-temperature gauge that measures a temperature of a surface of the heater, and a controller for performing a particle count detection process of obtaining a count of the particle in the gas. When the particle count detection process is performed, the controller obtains a flow rate of the gas on the basis of a calorific value that is supplied to the heater and a difference between the temperature of the gas and the temperature of the surface of the heater, with the heater heating the ventilation path, and obtains the count of the particle per unit volume in the gas on the basis of the flow rate of the gas and a physical quantity that varies depending on an electric charge amount of the charged particle that is collected by the charged-particle-collecting electrode.

When the particle count detection process is performed, the particle counter heats the ventilation path by using the heater. In this state, the flow rate of the gas is obtained on the basis of the calorific value that is supplied to the heater and the difference between the temperature of the gas and the temperature of the surface of the heater. The particle count per unit volume in the gas is obtained on the basis of the flow rate of the gas and the physical quantity that varies depending on the electric charge amount of the charged particle that is collected by the charged-particle-collecting electrode. The particle counter according to the first aspect of the present invention has a function of measuring the flow rate of the gas and can obtain the particle count per unit volume in the gas, and it is not necessary to prepare a flow meter.

In the particle counter according to the first aspect of the present invention, while the particle count detection process is not performed, the controller may cause the heater to heat the charged-particle-collecting electrode up to a predetermined particle incineration temperature to perform a refreshing process of incinerating the particle that is accumulated on the charged-particle-collecting electrode. This enables the heater to be used for detecting the flow rate of the gas and for refreshing the charged-particle-collecting electrode.

A particle counter according to a second aspect of the present invention includes a housing that has a ventilation path, a gas-temperature gauge that measures a temperature of gas that passes through the ventilation path, an electric-charge generator that generates an electric charge by air discharge in the ventilation path and applies the electric charge to a particle in the gas that passes through the ventilation path to obtain a charged particle, an excess-electric-charge-collecting electrode that collects an excess electric charge that is not applied to the particle, a heater that is capable of heating the ventilation path, a heater-temperature gauge that measures a temperature of a surface of the heater, and a controller for performing a particle count detection process of obtaining a count of the particle in the gas. When the particle count detection process is performed, the controller obtains a flow rate of the gas on the basis of a calorific value that is supplied to the heater and a difference between the temperature of the gas and the temperature of the surface of the heater, with the heater heating the ventilation path, and obtains the count of the particle per unit volume in the gas on the basis of the flow rate of the gas and a physical quantity that varies depending on an electric charge amount of the excess electric charge that is collected by the excess-electric-charge-collecting electrode.

When the particle count detection process is performed, the particle counter heats the ventilation path by using the heater. In this state, the flow rate of the gas is obtained on the basis of the calorific value that is supplied to the heater and the difference between the temperature of the gas and the temperature of the surface of the heater. The particle count per unit volume in the gas is obtained on the basis of the flow rate of the gas and the physical quantity that varies depending on the electric charge amount of the excess electric charge that is collected by the excess-electric-charge-collecting electrode. The particle counter according to the second aspect of the present invention has a function of measuring the flow rate of the gas and can obtain the particle count per unit volume in the gas, and it is not necessary to prepare a flow meter.

In the specification, the “electric charge” means not only a positive electric charge and a negative electric charge but also an ion. Examples of the “physical quantity” may include parameters that vary depending on the electric charge amount such as an electric current. The “calorific value that is supplied to the heater” can be represented by two physical quantities selected from an electric current that flows through the heater, a voltage that is applied across both of ends of the heater, and the resistance of the heater. Accordingly, the “calorific value that is supplied to the heater” may be the calorific value itself or may be the two physical quantities selected from the electric current that flows through the heater, the voltage that is applied across both of the ends of the heater, and the resistance of the heater.

In the particle counter according to the first or second aspect of the present invention, when the particle count detection process is performed, the controller may adjust the temperature of the surface of the heater to a temperature that is higher than the temperature of the gas and that is lower than an incineration temperature of the particle. The reason why the temperature of the surface of the heater is adjusted to a temperature higher than the temperature of the gas is that the gas that passes through the ventilation path removes heat that is supplied by the heater. The reason why the temperature of the surface of the heater is adjusted to a temperature lower than the particle incineration temperature is that the particle is prevented from being incinerated. In this way, the obtained particle count can be more accurate.

In the particle counter according to the first or second aspect of the present invention, the electric-charge generator may include an electric-discharge electrode and a ground electrode. The electric-discharge electrode may be disposed along an inner surface of the ventilation path. The ground electrode may be embedded in the housing or disposed along the inner surface of the ventilation path. In this case, the electric-charge generator is unlikely to hinder the flow of the gas that passes through the ventilation path, and the obtained flow rate of the gas can be more accurate. The electric-discharge electrode and the ground electrode may be joined to the inner surface of the ventilation path by using an inorganic material or may be joined to the inner surface of the ventilation path by sintering.

In the particle counter according to the first or second aspect of the present invention, the housing may have a thermal conductivity of no less than 3 and no more than 200 [W/m·K] at 20° C. In this case, the heat of the heater is relatively rapidly conducted to the ventilation path, and the responsiveness of adjustment of the temperature of the ventilation path by the heater is improved.

In the particle counter according to the first or second aspect of the present invention, the housing may be composed of ceramics. This improves the heat resistance of the particle counter because ceramics has high heat resistance. Examples of the ceramics include alumina and aluminum nitride. The thermal conductivity at 20° C. is 30 [W/m·K] for alumina and 150 [W/m·K] for aluminum nitride.

In the particle counter according to the first or second aspect of the present invention, the heater may be embedded in the housing. In this case, the heat of the heater is rapidly conducted to the ventilation path unlike the case where a heater is disposed outside the housing, and the responsiveness of adjustment of the temperature of the ventilation path by the heater is improved.

### BRIEF DESCRIPTION OF THE DRAWINGS

FIG. 1 is a schematic, sectional view of the structure of a particle counter 10.

FIG. 2 is a perspective view of an electric-charge generator 20.

FIG. 3 is a partial, sectional view of a structure for generating an electric field on collecting electrodes 30 and 40.

FIG. 4 is a schematic, sectional view of the structure of a particle counter 110.

### DETAILED DESCRIPTION OF THE INVENTION

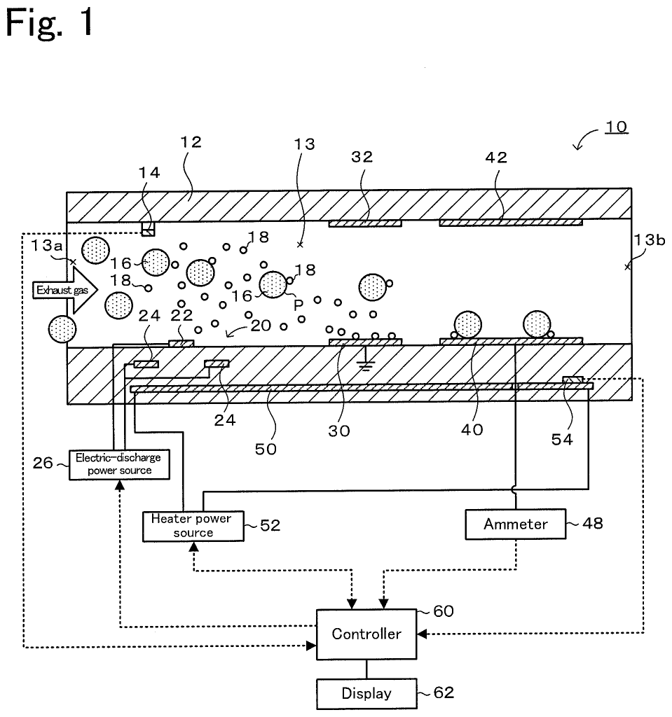

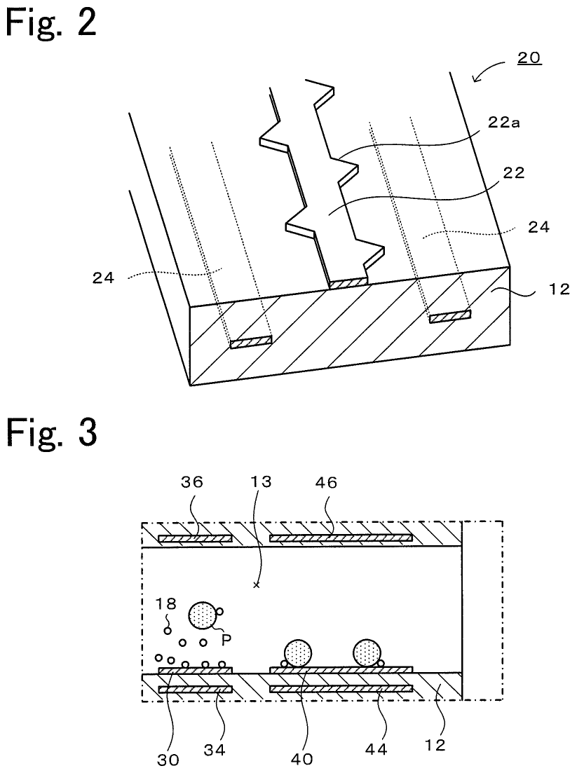

A preferred embodiment of the present invention will hereinafter be described with reference to the drawings. FIG. 1 is a schematic, sectional view of the structure of a particle counter 10. FIG. 2 is a perspective view of an electric-charge generator 20.

The particle counter 10 measures the count of particles that are contained in gas (for example, exhaust gas from an automobile). The particle counter 10 includes a housing 12, a gas-temperature gauge 14, the electric-charge generator 20, an excess-electric-charge-collecting electrode 30, a charged-particle-collecting electrode 40, a heater 50, a heater-temperature gauge 54, and a controller 60.

The housing 12 is composed of an insulating material and has a ventilation path 13. The ventilation path 13 extends through the housing 12 from a first opening 13a to a second opening 13b. An example of the insulating material is a ceramic material. The kind of the ceramic material is not particularly limited, and examples thereof include alumina, aluminum nitride, silicon carbide, mullite, zirconia, titania, silicon nitride, magnesia, glass, and a mixture thereof. The housing 12 preferably has a thermal conductivity of no less than 3 and no more than 200 [W/m·K] at 20° C. In the ventilation path 13, the electric-charge generator 20, the excess-electric-charge-collecting electrode 30, and the charged-particle-collecting electrode 40 are arranged in this order in the direction of the flow of the gas (in the direction from the opening 13a toward the opening 13b, here).

The gas-temperature gauge 14 is an element that measures the temperature Ta of the gas that passes through the ventilation path 13. The gas-temperature gauge 14 is disposed on an insulating member on the inner surface of the ventilation path 13.

The electric-charge generator 20 generates an electric charge in the ventilation path 13. The electric-charge generator 20 includes an electric-discharge electrode 22 and two ground electrodes 24. The electric-discharge electrode 22 is disposed along the inner surface of the ventilation path 13 and has fine projections 22a around a rectangle as illustrated in FIG. 2. The two ground electrodes 24 are rectangular electrodes and are embedded in a wall (housing 12) of the ventilation path 13 at an interval so as to be parallel to the electric-discharge electrode 22. In the electric-charge generator 20, a high-frequency high-voltage (for example, a pulse voltage) of an electric-discharge power source 26 is applied between the electric-discharge electrode 22 and the two ground electrodes 24, and air discharge occurs due to an electric potential difference between the electrodes. A part of the housing 12 between the electric-discharge electrode 22 and the ground electrodes 24 functions as a dielectric layer. The air discharge ionizes the gas around the electric-discharge electrode 22, and positive or negative electric charges 18 are generated. From the perspective of heat resistance during discharging, the material of the electric-discharge electrode 22 is preferably a metal the melting point of which is 1500° C. or more. Examples of the metal include titanium, chromium, iron, cobalt, nickel, niobium, molybdenum, tantalum, tungsten, iridium, palladium, platinum, gold and an alloy thereof. Among these, platinum and gold, which are unlikely to be ionized, are preferable from the perspective of corrosion resistance. The electric-discharge electrode 22 may be joined to the inner surface of the ventilation path 13 by using glass paste or may be formed as a sintered metal in a manner in which metal paste is applied to the inner surface of the ventilation path 13 by screen printing and fired. The same material as that of the electric-discharge electrode 22 can be used for the ground electrodes 24.

Particles 16 that are contained in the gas enter the ventilation path 13 via the opening 13a and become charged particles P by receiving the electric charges 18 that are generated by the air discharge of the electric-charge generator 20 when passing through the electric-charge generator 20, and the charged particles P move downstream. Some of the electric charges 18 generated are not applied to the particles 16 and move downstream as it is.

The excess-electric-charge-collecting electrode 30 is an electrode that removes the electric charges 18 that are not applied to the particles 16 and is disposed along the inner surface of the ventilation path 13. An electric-field-generating electrode 32 for collecting excess electric charges is disposed on the ventilation path 13 so as to face the excess-electric-charge-collecting electrode 30. The electric-field-generating electrode 32 is also disposed along the inner surface of the ventilation path 13. When the voltage of an electric-field generation power source, not illustrated, is applied between the electric-field-generating electrode 32 and the excess-electric-charge-collecting electrode 30, an electric field is generated between the electric-field-generating electrode 32 and the excess-electric-charge-collecting electrode 30 (on the excess-electric-charge-collecting electrode 30). The electric charges 18 that are generated by the air discharge of the electric-charge generator 20 and that are not applied to the particles 16 are attracted to the excess-electric-charge-collecting electrode 30 by the electric field, collected, and released to the GND (ground).

The charged-particle-collecting electrode 40 is disposed along the inner surface of the ventilation path 13. The charged-particle-collecting electrode 40 collects the charged particles P. An electric-field-generating electrode 42 for collecting the charged particles is disposed on the ventilation path 13 so as to face the charged-particle-collecting electrode 40. The electric-field-generating electrode 42 is disposed along the inner surface of the ventilation path 13. When the voltage of the electric-field generation power source, not illustrated, is applied between the electric-field-generating electrode 42 and the charged-particle-collecting electrode 40, an electric field is generated between the electric-field-generating electrode 42 and the charged-particle-collecting electrode 40 (on the charged-particle-collecting electrode 40). The charged particles P are attracted to the charged-particle-collecting electrode 40 by the electric field and collected. An ammeter 48 is connected to the charged-particle-collecting electrode 40. The ammeter 48 detects an electric current that flows through the charged-particle-collecting electrode 40 for an output to the controller 60.

The sizes of the collecting electrodes 30 and 40 and the intensities of the electric fields on the collecting electrodes 30 and 40 are set such that the charged particles P are not collected by the excess-electric-charge-collecting electrode 30 but are collected by the charged-particle-collecting electrode 40, and that the electric charges 18 that are not applied to the particles 16 are collected by the excess-electric-charge-collecting electrode 30.

The heater 50 is embedded in the wall (housing 12) of the ventilation path 13. The heater 50 is connected to a heater power source 52. The heater power source 52 applies a voltage between terminals that are disposed on both of ends of the heater 50 to cause an electric current to flow through the heater 50, and consequently, the heater 50 generates heat. The material of the heater 50 preferably has a relatively high resistance temperature coefficient, and examples thereof include platinum, gold, silver, copper, iron, nickel, molybdenum, and tungsten. A material that has a thermal expansion coefficient close to that of the material of the housing 12 is preferably selected. To decrease the difference in the thermal expansion coefficient between the heater 50 and the housing 12, the heater 50 may contain powder (for example, ceramic powder such as alumina powder or zirconia powder) of the material of the housing 12.

The heater-temperature gauge 54 is an element that measures the temperature T of a surface of the heater 50. The heater-temperature gauge 54 is disposed on the surface of the heater 50.

The controller 60 includes a known microcomputer that includes a CPU, a ROM, a RAM, and so on. The controller 60 adjusts the voltage of the electric-discharge power source 26 and the voltage of the heater power source 52, receives the magnitude of the temperature from the gas-temperature gauge 14 and the heater-temperature gauge 54, and receives the magnitude of the electric current that flows through the charged-particle-collecting electrode 40 from the ammeter 48. The controller 60 obtains the particle count per unit volume in the gas that passes through the ventilation path 13 and causes a display 62 to display the result.

An example of manufacture of the particle counter 10 will now be described. The housing 12 of the particle counter 10 that includes the electrodes 22, 24, 30, 32, 40, and 42, the gas-temperature gauge 14, the heater 50, and the heater-temperature gauge 54 can be manufactured by using ceramic green sheets. Specifically, after a notch, a through-hole, or a groove is formed in each ceramic green sheet, an electrode and a wiring pattern are formed on the ceramic green sheet by screen printing, and a temperature gauge element is disposed on the ceramic green sheet as needed, the ceramic green sheets are stacked and fired. The notch, the through-hole, and the groove may be filled with a material (for example, an organic material) that is incinerated during firing. The housing 12 that includes the electrodes 22, 24, 30, 32, 40, and 42, the gas-temperature gauge 14, the heater 50, and the heater-temperature gauge 54 is thus obtained. Subsequently, the electric-discharge power source 26 is connected to the electric-discharge electrode 22 and the ground electrodes 24, the ammeter 48 is connected to the charged-particle-collecting electrode 40, and the heater power source 52 is connected to the heater 50. The controller 60 is connected to the electric-discharge power source 26, the ammeter 48, the heater power source 52, and the display 62. In this way, the particle counter 10 can be manufactured.

An example of the use of the particle counter 10 will now be described. In the case where the count of the particles 16 that are contained in exhaust gas of an automobile is detected, the particle counter 10 is installed in an exhaust pipe of an engine. At this time, the particle counter 10 is installed such that the exhaust gas enters the ventilation path 13 via the opening 13a of the particle counter 10 and exits via the opening 13b.

The controller 60 performs a particle count detection process of obtaining the count of the particles 16 in the gas. At this time, the controller 60 causes the heater 50 to heat the ventilation path 13. Specifically, the controller 60 receives the magnitude of the temperature Ta of the gas from the gas-temperature gauge 14 and receives the magnitude of the temperature T of the surface of the heater 50 from the heater-temperature gauge 54 to control the voltage V_{H} of the heater power source 52 that is applied to the heater 50 such that the temperature Ta of the gas becomes a predetermined temperature. The controller 60 gradually increases the voltage V_{H} across both of the ends of the heater 50 to increase the temperature T of the surface of the heater 50 until the temperature Ta of the gas reaches the predetermined temperature. In the case where the flow velocity of the gas is high, the amount of heat that the gas removes from the housing 12 increases. In the case where the flow velocity of the gas is low, the amount of the heat that the gas removes from the housing 12 decreases. Accordingly, as the flow velocity of the gas increases, the temperature T of the surface of the heater 50 increases. The controller 60 adjusts the temperature T of the heater 50 to a temperature that is higher than the temperature Ta of the gas and that is lower than the incineration temperature (for example, 600° C.) of the particles 16.

A calorific value (dissipation calorific value) Q_{H} that is transferred from the housing 12 to the gas is expressed as the expression (1) below. A calorific value (supply calorific value) Q that is supplied to the heater 50 is expressed as the expression (2) below. The expression (1) is referred to as the King's expression. The supply calorific value Q is equal to the dissipation calorific value Q_{H} as a result of a cooling action of the gas. Accordingly, the right-hand side of the expression (1) is equal to the right-hand side of the expression (2). Here, a and b are constants, T and Ta are measured values, and V_{H} is a value that is adjusted by the controller 60. The resistance R_{H} of the heater 50 is a function of temperature and can be calculated from the temperature T of the surface of the heater 50. Accordingly, the controller 60 can obtain the flow velocity U of the gas from these expressions. The flow rate q (volume flow rate) of the gas is obtained by multiplying the flow velocity U by a sectional area S of the ventilation path 13, and the controller 60 can also obtain the flow rate q of the gas from these expressions.

Q_{H}=(a+b×U^{1/2})×(T−Ta) (1),

where a and b are constants depending on the gas and the shape of the heater 50,

U is the flow velocity of the gas,

Ta is the temperature of the gas, and

T is the temperature of the surface of the heater 50,

Q=V_{H}²/R_{H} (2),

V_{H} is the voltage across both of the ends of the heater 50, and

R_{H} is the resistance of the heater 50

The controller 60 adjusts the voltage of the electric-discharge power source 26 that is applied between the electric-discharge electrode 22 and the ground electrodes 24 such that the count of the electric charges 18 that are generated by the air discharge of the electric-charge generator 20 exceeds the count of the particles 16 that are presumably contained in the gas. The particles 16 in the gas that enters the ventilation path 13 become the charged particles P by receiving the electric charges 18 when passing through the electric-charge generator 20. The charged particles P are not collected by the excess-electric-charge-collecting electrode 30, move along the flow of the gas, and are subsequently collected by the charged-particle-collecting electrode 40. Some of the electric charges 18 that are generated by the electric-charge generator 20 and that are not applied to the particles 16 are collected by the excess-electric-charge-collecting electrode 30 and released to the GND.

The controller 60 obtains the particle count per unit volume on the basis of the flow rate q of the gas and the detected electric current that is received from the ammeter 48 that is connected to the charged-particle-collecting electrode 40, and causes the display 62 to display the particle count. The particle count per unit volume (the unit is count/cc) in the gas is calculated from the expression (3) below. In the expression (3), the detected electric current (the unit is A (=C/s)) corresponds to the magnitude of the electric current that is received from the ammeter 48. An average charge count (the unit is count) is the average of the electric charges 18 that are applied to a single one of the particles 16 and can be calculated in advance from measured values of a microammeter and a particle counter. An elementary charge quantity (the unit is C) is a constant that is referred to also as a charge elementary quantity. A flow rate (the unit is cc/s) is the flow rate q of the gas that is calculated in the above manner.

Particle Count=(Detected Electric Current)/{(Average Charge Count)×(Elementary Charge Quantity)×(Flow Rate)} (3)

With the timing of a refreshing process while the particle count detection process is not performed, the controller 60 causes the heater 50 to heat the charged-particle-collecting electrode 40 up to a predetermined particle incineration temperature (for example, 600° C. or 700° C.) to perform the refreshing process of incinerating the particles 16 that are accumulated on the charged-particle-collecting electrode 40. For example, the refreshing process may be repeatedly performed whenever a predetermined period elapses, may be repeatedly performed whenever the count of the particles that are accumulated on the charged-particle-collecting electrode 40 reaches a predetermined count, or may be repeatedly performed whenever a predetermined time elapses with the flow rate of the gas being zero because of clogging of the ventilation path 13. The controller 60 does not perform the particle count detection process while the refreshing process is performed.

The particle counter 10 described above performs the particle count detection process with the heater 50 heating the ventilation path 13. In this state, the flow rate q of the gas is obtained on the basis of the calorific value Q (for example, the voltage V_{H} across both of the ends of the heater 50 and the resistance R_{H} of the heater 50) that is supplied to the heater 50 and the difference (=T−Ta) between the temperature Ta of the gas and the temperature T of the surface of the heater 50. The particle count per unit volume in the gas is obtained on the basis of the flow rate q of the gas and a physical quantity (the electric current that flows through the charged-particle-collecting electrode 40) that varies depending on the electric charge amount of the charged particles P that are collected by the charged-particle-collecting electrode 40. The particle counter 10 has a function of measuring the flow rate q of the gas and can thus obtain the count of the particles 16 per unit volume in the gas, and it is not necessary to prepare a flow meter.

When the particle count detection process is performed, the controller 60 adjusts the temperature T of the surface of the heater 50 to a temperature that is higher than the temperature Ta of the gas and that is lower than the incineration temperature of the particles 16. The reason why the temperature T of the surface of the heater 50 is adjusted to a temperature higher than the temperature Ta of the gas is that the gas that passes through the ventilation path 13 removes heat that is supplied to the housing 12 by the heater 50. The reason why the temperature of the surface of the heater 50 is adjusted to a temperature lower than the particle incineration temperature is that the particles are prevented from being incinerated. In this way, the obtained count of the particles 16 can be more accurate.

The particle counter 10 obtains the flow rate of the gas in accordance with a so-called principle of a thermal flow meter. Accordingly, the heater 50 can be used for detecting the flow rate of the gas and for refreshing the charged-particle-collecting electrode 40.

The electric-discharge electrode 22 is disposed along the inner surface of the ventilation path 13. The ground electrodes 24 are embedded in the wall (housing 12) of the ventilation path 13. Accordingly, the electric-charge generator 20 is unlikely to hinder the flow of the gas that passes through the ventilation path 13. Consequently, the obtained flow rate of the gas can be more accurate.

The housing 12 has a thermal conductivity of no less than 3 and no more than 200 [W/m·K] at 20° C. Accordingly, the heat of the heater 50 is relatively rapidly conducted to the ventilation path 13, and responsiveness of adjustment of the temperature Ta by the heater 50 is improved. The housing 12 that is composed of a ceramics improves the heat resistance of the particle counter 10.

The heater 50 is embedded in the wall (housing 12) of the ventilation path 13. Accordingly, the heat of the heater 50 is rapidly conducted to the ventilation path 13 unlike the case where a heater is disposed outside the housing 12. Consequently, the responsiveness of adjustment of the temperature Ta by the heater 50 is improved.

The charged-particle-collecting electrode 40 collects the charged particles P by using the electric field. Accordingly, the charged-particle-collecting electrode 40 can effectively collect the charged particles P.

It goes without saying that the present invention is not limited to the above embodiment, and that the present invention can be carried out with various embodiments within the technical range thereof.

For example, although the electric-field-generating electrodes 32 and 42 are disposed along the inner surface of the ventilation path 13 according to the above embodiment, the electric-field-generating electrodes 32 and 42 may be embedded in the wall (housing 12) of the ventilation path 13. As illustrated in FIG. 3, a pair of electric-field-generating electrodes 34 and 36 may be embedded in the wall of the ventilation path 13 so as to interpose the excess-electric-charge-collecting electrode 30 instead of the electric-field-generating electrode 32, and a pair of electric-field-generating electrodes 44 and 46 may be embedded in the wall of the ventilation path 13 so as to interpose the charged-particle-collecting electrode 40 instead of the electric-field-generating electrode 42. In this case, when a voltage is applied to the pair of the electric-field-generating electrodes 34 and 36 to generate an electric field on the excess-electric-charge-collecting electrode 30, the electric charges 18 are collected by the excess-electric-charge-collecting electrode 30. When a voltage is applied to the pair of the electric-field-generating electrodes 44 and 46 to generate an electric field on the charged-particle-collecting electrode 40, the charged particles P are collected by the charged-particle-collecting electrode 40.

Although the electric-charge generator 20 includes the electric-discharge electrode 22 that is disposed along the inner surface of the ventilation path 13 and the two ground electrodes 24 that are embedded in the housing 12 according to the above embodiment, the electric-charge generator 20 may has any structure provided that an electric charge is generated by the air discharge. For example, the ground electrodes 24 may not be embedded in the wall of the ventilation path 13 but may be disposed along the inner surface of the ventilation path 13. In this case, each of the ground electrodes 24 may be joined to the inner surface of the ventilation path 13 by using glass paste, or may be formed as a sintered metal in a manner in which metal paste is applied to the inner surface of the ventilation path 13 by screen printing and fired. As disclosed in International Publication No. 2015/146456, the electric-charge generator may include a needle-shaped electrode and a facing electrode.

Although the heater 50 is embedded in the lower wall of the ventilation path 13 according to the above embodiment, the heater 50 may be embedded in the upper wall of the ventilation path 13, or may be embedded in the upper and lower walls of the ventilation path 13. The heater 50 in the form of a tube or spiral may be embedded in the housing 12. The heater 50 may not be embedded in the housing 12 but may be disposed on the outer surface of the housing 12.

Although the gas-temperature gauge 14 is installed near the inner surface of the ventilation path 13 according to the above embodiment, the gas-temperature gauge 14 may be installed near the central axis of the ventilation path 13.

Although the electric-charge generator 20 is disposed below the ventilation path 13 according to the above embodiment, the electric-charge generator 20 may be disposed above the ventilation path 13, or may be disposed above and below the ventilation path 13.

According to the above embodiment, the electric field is generated on the charged-particle-collecting electrode 40. However, even when no electric field is generated, the charged particles P can be collected by the charged-particle-collecting electrode 40 by adjusting a space (the thickness of a flow path) in which the charged-particle-collecting electrode 40 is disposed on the ventilation path 13 to a small value (for example, no less than 0.01 mm and less than 0.2 mm). That is, when the thickness of the flow path is a small value, the charged particles P can be collected by the charged-particle-collecting electrode 40 by being collided therewith because Brownian motion of the charged particles P is intense. In this case, the electric-field-generating electrode 42 may not be provided.

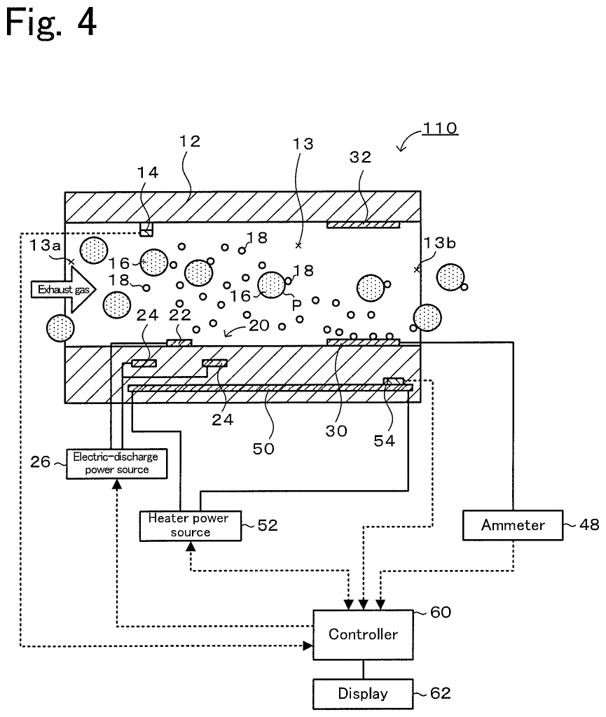

Although the particle count per unit volume in the gas is obtained by using the particle counter 10 according to the above embodiment, the particle count per unit volume in the gas may be obtained by using a particle counter 110 illustrated in FIG. 4. The particle counter 110 has the same structure as that of the particle counter 10 except that the charged-particle-collecting electrode 40 and the electric-field-generating electrode 42 are not provided, and that the ammeter 48 is connected to the excess-electric-charge-collecting electrode 30 and the controller 60. Accordingly, components like to those of the particle counter 10 are designated by like reference signs. The ammeter 48 detects an electric current that flows through the excess-electric-charge-collecting electrode 30 for an output to the controller 60. The voltage that is applied between the electric-discharge electrode 22 and the ground electrodes 24 is adjusted such that a predetermined amount of the electric charges 18 are generated per unit time. The size of the excess-electric-charge-collecting electrode 30 and the intensity of the electric field on the excess-electric-charge-collecting electrode 30 are set such that the excess-electric-charge-collecting electrode 30 collects the excess electric charges but does not collect the charged particles P. Accordingly, the charged particles P are not collected by the excess-electric-charge-collecting electrode 30 and exit to the outside via the opening 13b of the ventilation path 13. When the particle count detection process is performed, the controller 60 of the particle counter 110 obtains the flow rate q of the gas on the basis of the calorific value Q that is supplied to the heater 50 and the difference (=T−Ta) between the temperature Ta of the gas and the temperature T of the surface of the heater 50, with the heater 50 heating the ventilation path 13 as in the above embodiment. The particle count per unit volume (the unit is count/cc) in the gas is obtained on the basis of the flow rate q of the gas and the physical quantity (electric current) that varies depending on the electric charge amount of the excess electric charges that are collected by the excess-electric-charge-collecting electrode 30. The particle count per unit volume in the gas is obtained in a manner in which the count (=electric current/elementary charge quantity) of the excess electric charges per unit time is obtained on the basis of the electric current that flows through the excess-electric-charge-collecting electrode 30, a difference obtained by subtracting the count of the excess electric charges from the total count of the electric charges 18 that are generated by the electric-charge generator 20 per unit time is divided by the average charge count of the charged particles P to obtain a charged particle count, and the charged particle count is divided by the flow rate q. The particle counter 110 also has the function of measuring the flow rate of the gas and can obtain the particle count per unit volume in the gas, and it is not necessary to prepare a flow meter.

The application claims priority to Japanese Patent Application No. 2017-159492 filed in the Japan Patent Office on Aug. 22, 2017, the entire contents of which are incorporated herein by reference.

What is claimed is:

1. A particle counter comprising:
a housing that has a ventilation path;
a gas-temperature gauge that measures a temperature of gas that passes through the ventilation path;
an electric-charge generator that generates an electric charge by air discharge in the ventilation path and applies the electric charge to a particle in the gas that passes through the ventilation path to obtain a charged particle;
a charged-particle-collecting electrode that collects the charged particle;
a heater that is capable of heating the ventilation path;
a heater-temperature gauge that measures a temperature of a surface of the heater; and
a controller for performing a particle count detection process of obtaining a count of the particle in the gas,
wherein, when the particle count detection process is performed, the controller obtains a flow rate of the gas on the basis of a calorific value that is supplied to the heater and a difference between the temperature of the gas and the temperature of the surface of the heater, with the heater heating the ventilation path, and obtains the count of the particle per unit volume in the gas on the basis of the flow rate of the gas and a physical quantity that varies depending on an electric charge amount of the charged particle that is collected by the charged-particle-collecting electrode.

2. A particle counter comprising:
a housing that has a ventilation path;
a gas-temperature gauge that measures a temperature of gas that passes through the ventilation path;
an electric-charge generator that generates an electric charge by air discharge in the ventilation path and applies the electric charge to a particle in the gas that passes through the ventilation path to obtain a charged particle;
an excess-electric-charge-collecting electrode that collects an excess electric charge that is not applied to the particle;
a heater that is capable of heating the ventilation path;
a heater-temperature gauge that measures a temperature of a surface of the heater; and
a controller for performing a particle count detection process of obtaining a count of the particle in the gas,
wherein, when the particle count detection process is performed, the controller obtains a flow rate of the gas on the basis of a calorific value that is supplied to the heater and a difference between the temperature of the gas and the temperature of the surface of the heater, with the heater heating the ventilation path, and obtains the count of the particle per unit volume in the gas on the basis of the flow rate of the gas and a physical quantity that varies depending on an electric charge amount of the excess electric charge that is collected by the excess-electric-charge-collecting electrode.

3. The particle counter according to claim 1,
wherein, while the particle count detection process is not performed, the controller causes the heater to heat the charged-particle-collecting electrode up to a predetermined particle incineration temperature to perform a refreshing process of incinerating the particle that is accumulated on the charged-particle-collecting electrode.

4. The particle counter according to claim 1,
wherein, when the particle count detection process is performed, the controller adjusts the temperature of the surface of the heater to a temperature that is higher than the temperature of the gas and that is lower than an incineration temperature of the particle.

5. The particle counter according to claim 1,
wherein the electric-charge generator includes an electric-discharge electrode and a ground electrode,
wherein the electric-discharge electrode is disposed along an inner surface of the ventilation path, and
wherein the ground electrode is embedded in the housing or disposed along the inner surface of the ventilation path.

6. The particle counter according to claim 1,
wherein the housing has a thermal conductivity of no less than 3 and no more than 200 [W/m·K] at 20° C.

7. The particle counter according to claim 1,
wherein the housing is composed of ceramics.

8. The particle counter according to claim 1,
wherein the heater is embedded in the housing.

9. The particle counter according to claim 2,
wherein, when the particle count detection process is performed, the controller adjusts the temperature of the surface of the heater to a temperature that is higher than the temperature of the gas and that is lower than an incineration temperature of the particle.

10. The particle counter according to claim 2,
wherein the electric-charge generator includes an electric-discharge electrode and a ground electrode,
wherein the electric-discharge electrode is disposed along an inner surface of the ventilation path, and
wherein the ground electrode is embedded in the housing or disposed along the inner surface of the ventilation path.

11. The particle counter according to claim 2,
wherein the housing has a thermal conductivity of no less than 3 and no more than 200 [W/m·K] at 20° C.

12. The particle counter according to claim 2,
wherein the housing is composed of ceramics.

13. The particle counter according to claim 2,
wherein the heater is embedded in the housing.
